(19) United States
(12) Patent Application Publication
(10) Pub. No.: US 2019/0381950 A1
(43) Pub. Date: Dec. 19, 2019

(54) METHODS, SYSTEMS AND APPARATUS FOR AN IN-VEHICLE FLEXIBLE VIEWING PLATFORM

(71) Applicants: Alexander Morrison, Newport Beach, CA (US); Ifiok Akpandak, New York, NM (US)

(72) Inventors: Alexander Morrison, Newport Beach, CA (US); Ifiok Akpandak, New York, NM (US)

(21) Appl. No.: 16/010,477

(22) Filed: Jun. 17, 2018

(51) Int. Cl. B60R 11/02

(52) U.S. Cl. CPC B60R 11/0229; B60R 11/0252; B60R 2011/0276; B60R 2300/50; B60R 11/0241

(57) ABSTRACT

An apparatus that can secure an electronic device to a vehicle center console. The apparatus provides a platform to mount and secure an electronic device atop of the vehicle's center console, which is the space between the driver and passenger front seats. The apparatus contains a connection assembly system that secures the apparatus to the center console. Once the apparatus is attached to the center console, electronic devices can be mounted on it. The electronic device can be positioned to face any passenger in the vehicle to interact with. The vehicle may comprise one or more of the following: automobile, van, truck, autonomous vehicle, airplane, helicopter, boat.

### FIELD OF THE INVENTION

The disclosure and embodiments of the invention relate to a system and method of displaying electronic devices towards all passengers in a vehicle.

### BACKGROUND OF THE INVENTION

Ridesharing use has exploded in popularity over the past few years. Real-time ridesharing is a service that arranges one-time shared rides on short notice, where a passenger travels in a private vehicle driven by the vehicle's owner. Prior to the advent of ridesharing, the typical way of arranging one-time rides happened through Taxi Cabs. Ridesharing has differentiated itself from Taxi Cabs by offering greater convenience, through mobile application based ordering, and a greater experience, among other things.

There are multiple real-time rideshare service providers that go to great lengths to differentiate their services and provide a unique rideshare experience. These differentiating factors include promotions, product offerings, discounts, and more. Interactive entertainment is one way rideshare service providers can differentiate their services. Typically, these service providers own mobile applications that their customers download. On the mobile applications, customers can order one-time share rides, as well as interact with the application. Service providers upload unique and engaging content to keep their customers engaged.

The Taxi Cab industry is not a stranger to providing their customers with interactive entertainment. Taxi Cab TVs, where a display is built into the Taxi Cab and displays information to passengers while they sit in their ride. In certain markets like New York City these are ubiquitous. Large Taxi Cab companies will retrofit out their taxis with TVs and rent them to drivers.

But rideshare service providers operate by using the “gig” economy to supply their workforce. Instead of managing and leasing out a fleet of cars, rideshare companies hire independent contractors who drive their own personal vehicles, some part time and some full time. Because these companies do not own most vehicles themselves, they have not incorporated any interactive devices into the vehicles, instead relying on the mobile applications.

Therefore, a need exists for an interactive entertainment display for vehicles. It is the objective of the present invention to provide a platform to secure an electronic device to. Once the device is secured, the passengers in the car can interact with it.

### BRIEF SUMMARY OF THE INVENTION

Methods, Systems and apparatus are disclosed for an in-vehicle flexible viewing platform. The present invention comprises a platform. On that platform is a pad where a device can be mounted. A coupling device may also be mounted on the pad, which a device can then be placed on. The coupling device may connect directly to the pad. The pad can be swiveled or rotated in any direction. The device will face the direction that the pad is rotated towards, and once there, a passenger in the car can interact with it. The platform comprises strap guides that line its sides. Attachment devices may be affixed to the strap guides, which are then used to secure the platform to the vehicle's center console. As described, the attachment devices are Velcro straps that are threaded through the holes inside the platform and through the strap guides, and then looped around and under the center console of the vehicle to secure it.

### BRIEF DESCRIPTION OF THE DRAWINGS

The drawings illustrate only exemplary embodiments of the invention and therefore do not limit its scope because the inventive concepts lend themselves to other equally effective embodiments.

FIG. 1 is a diagram illustrating the invention in a vehicle system.

FIG. 2 is a diagram illustrating the base assembly of the invention with an electronic device secured.

FIG. 3 is a diagram of the base assembly of the invention without an electronic device secured. This diagram also shows how the pad can be swiveled, and how the connection straps work.

FIG. 4 illustrates the swivel mechanism that facilitates the electric device to rotate.

FIG. 5 illustrates the tilting mechanism that facilitates the electronic device to be tilted up and tilted down.

### DETAILED DESCRIPTION OF THE INVENTION

The drawings illustrate only exemplary embodiments of the invention and therefore do not limit its scope because the inventive concepts lend themselves to other equally effective embodiments.

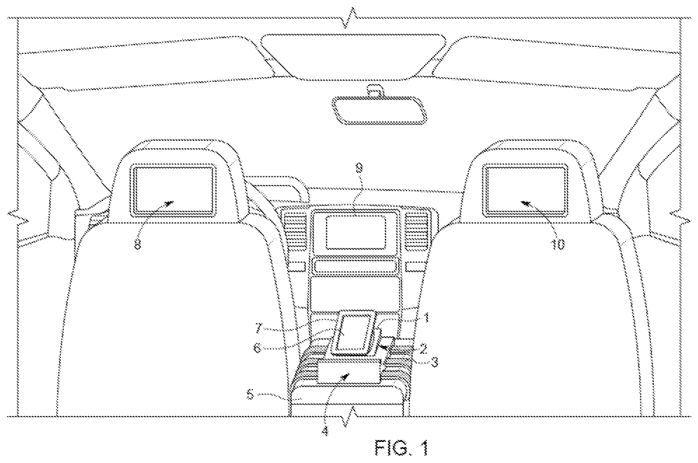

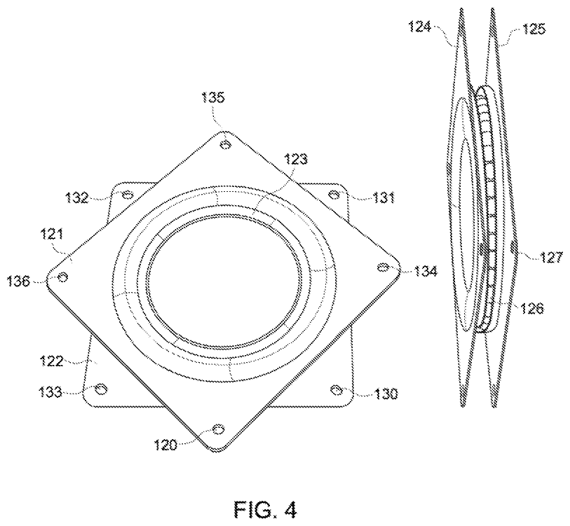

FIG. 1 shows the invention in a vehicle system (generally designated). A device FIG. 1, 7 is attached to the center console FIG. 1, 5 of a vehicle (generally designated). The device FIG. 1, 7 shown is an electronic tablet, but a device may comprise one or more of the following, electronic or non-electronic, including: tablets, phones, wearable devices, music players, book readers, iPad, iPhone, android device, Virtual Reality or Augmented Reality headsets. The vehicle may comprise one or more of the following: automobile, van, truck, autonomous vehicle, airplane, helicopter, boat. The device FIG. 1, 7 is attached to a standing pad FIG. 1, 1 which is attached to a swivel mechanism FIG. 1, 2, FIG. 4. Rather than changing the orientation of the entire device FIG. 1, 7 to allow a passenger to directly face the device FIG. 1, 7, the swivel mechanism FIG. 1, 2, FIG. 4 may be used to turn the standing pad FIG. 1, 1 so it is facing any passenger, including passengers in the front seat as well as the driver, which also directs the device FIG. 1, 7 to be facing that same direction. This allows for an easier use of the device FIG. 1, 7. The standing pad FIG. 1, 1 is flat and sloping and can be adjusted to apply varying degrees of tilt, either up or down or tilt left or tilt right. Certain devices may require different degrees of tilt depending on the shape of the device FIG. 1, 7. The device FIG. 1, 7 can be attached directly on the standing pad FIG. 1, 1, or attached to another device, not shown, which is in turn attached to the standing pad FIG. 1, 1. The purpose of using another device is for added functionality, such as a recoil cord system that allows the device to be picked up but not removed. This is only one depiction of the design, and another coupling device may not need to be used.

The device FIG. 1, 7 shown is an electronic tablet, but a device may comprise one or more of the following, electronic or non-electronic, including: tablets, phones, wearable devices, music players, book readers, iPad, iPhone, android device, Virtual Reality or Augmented Reality headsets. As shown, the device FIG. 1, 7 consists of a screen FIG. 1, 6 that displays information. Information can be relayed from screen FIG. 1, 6, to other possible vehicle screens, which may comprise the vehicle dashboard FIG. 1, 9, as well as to the vehicle headrests FIG. 1, 8 10. The device FIG. 1, 7 may not have a screen as previously mentioned.

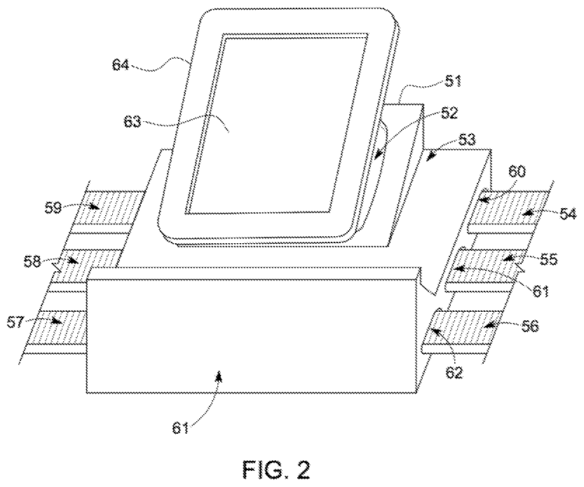

The frame FIG. 1, 4, FIG. 2, 53 61 is attached to the center console FIG. 1, 5 via connecting straps FIG. 1, 3, FIG. 2, 54 55 56 57 58 59 located on the left and right sides of the frame base FIG. 1, 4, FIG. 2, 53 61. The connecting strap guides FIG. 2, 60 61 62 can be located at front, back or middle portions of the frame base FIG. 1, 4 FIG. 2, 53 61, and one or more connecting straps FIG. 1, 3, FIG. 2, 54 55 56 57 58 59 may be used to secure the device. In this diagram, six connecting straps are being used, three straps on each side FIG. 2, 54 55 56 57 58 59, to secure the frame to the center console FIG. 1, 5. Connecting straps FIG. 1, 3 FIG. 2, 54 55 56 57 58 59 secure the frame base FIG. 1, 4, FIG. 2, 53 61 to the center console FIG. 1, 5 of the vehicle. As shown the connecting straps FIG. 1, 3, FIG. 2, 54 55 56 57 58 59 are Velcro straps, that are arranged horizontally and connect to the connecting strap base guides FIG. 2, 60 61 62. Using connecting straps, the installation procedure would involve looping the connecting straps around the sides of the center console FIG. 1, 5, where each end of the connecting strap would meet on the underside and connect with each other, thus securing the frame FIG. 1, 4, FIG. 2, 53 61 to the center console FIG. 1, 5. This is just one example of an installation, and this would change depending on the connecting device used. The connecting device may include Velcro straps shown or one or more of the following: clips, bolts, screws, adhesive tape, hook and loop tape, hook pile tape, scratch tape or other means to secure the frame. Installation for other types of connecting devices could secure directly to the center console, or be built into the center console altogether.

FIG. 2 shows a detail of the platform FIG. 2, 53 61 with an electronic device mounted on it. The platform consists of a pad FIG. 2, 51, which sits on top of the platform FIG. 2, 53. The electronic device FIG. 2, 62 is mounted onto the pad FIG. 2, 51. In the diagram as shown, a coupling device FIG. 2, 52 attaches to both the electronic device FIG. 2, 62 and the pad 51. The coupling device FIG. 2, 52 is attached to the pad FIG. 2, 51. This is just one example of how to mount an electronic device to the platform. The electronic device itself may be mounted directly to the pad without using a coupling device FIG. 2, 52. The platform FIG. 2, 53 has connecting strap base guides FIG. 2, 60 61 62 (only one side of the base is labeled) that are used to guide the connecting straps FIG. 2, 54 55 56 57 58 59 through the base FIG. 2, 61 to secure the platform FIG. 1, 5 FIG. 2, 53 61 to the center console FIG. 1, 5 of a vehicle. In the diagram as shown, there are six connecting strap guides FIG. 2, 60 61 62 that are on the sides of the platform FIG. 2, 53 61. Coming out of the connecting strap guides are connecting straps FIG. 2, 54 55 56 57 58 59 that connect to the connecting strap guides FIG. 2, 60 61 62 and loop around the center console FIG. 1, 5 of a vehicle to secure the platform. This is just one example of how the connecting straps may work. There may one or more connecting straps or other methods to attach the base FIG. 1, 4 FIG. 2, 53 61 to the center console FIG. 1, 5. As shown, the connecting straps FIG. 2, 54 55 56 57 58 59 are Velcro straps. The attachment device may include the Velcro straps shown or one or more of the following: clips, bolts, screws, adhesive tape or other means to secure the frame. Installation for other types of attachment devices could secure directly to the center console, or be built into the center console altogether.

The electronic device FIG. 2, 64 comprises a screen FIG. 2, 63 that faces a passenger of the vehicle. The front of the platform FIG. 2, 61 contains space for information. The space may comprise one or more of the following, a clear container where printed material can be located, an electronic screen to display information. The printed material may comprise one or more of the following, images that advertise products, handouts that advertise products, coupons for discounts at various venues.

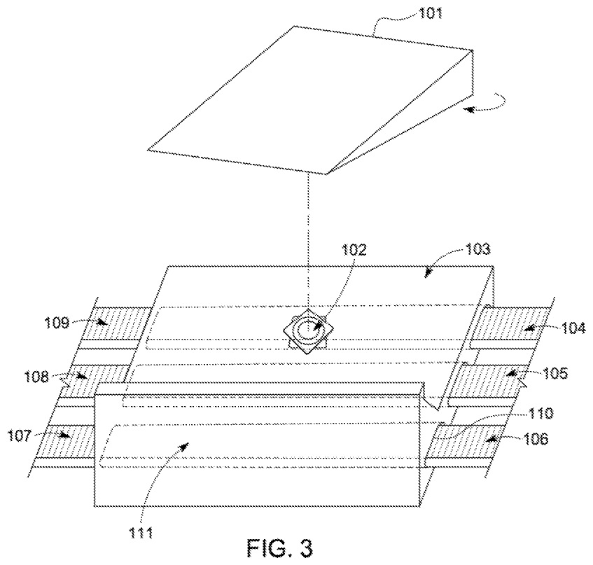

FIG. 3 shows a detail of the platform without an electronic device mounted on it. The platform FIG. 3, 103 consists of a pad FIG. 3, 101 that is attached to the platform by a swivel mechanism FIG. 3, 102. In this diagram, the pad 101 has been moved up to exhibit how the swivel mechanism FIG. 3, 102, FIG. 4 is located underneath it. The pad FIG. 3, 101 can be turned in any direction by use of the spinning swivel mechanism. Whichever way the pad is turned, the device mounted on it will also turn that way. The platform FIG. 3, 103 has connecting strap guides FIG. 3, 110 that are located on it's sides. This diagram shows how the center of the platform FIG. 3, 103 has hollow tubes FIG. 3, 111 that attach to each of the connecting strap guides FIG. 3, 110. Connecting straps FIG. 3, 104 105 106 107 108 109 feed through connecting strap guides FIG. 3, 110 (only one is labeled) into the hollow tubes FIG. 3, 111. As shown in FIG. 1, these attachment devices feed around the center console FIG. 1, 5 of a vehicle, securing the platform FIG. 3, 103.

FIG. 4 shows one possible swivel mechanism. The swivel mechanism is located in the base, FIG. 3, 102. The swivel mechanism rotates either clockwise or counter clockwise to allow the electronic device coupled to it to rotate. The swivel mechanism consists of two metal plates, FIG. 4, 121 122 124 125 coupled by a ring FIG. 4, 123 of ball bearings FIG. 4, 106. The ball bearings allow the metal plates to rotate freely. The two metal plates FIG. 4, 121 122 124 125 may attach to the base FIG. 3, 103 and the platform FIG. 3, 101 through screws driven through the predrilled holes in the switch mechanism metal plates FIG. 4, 120 130 131 132 133 134 135.

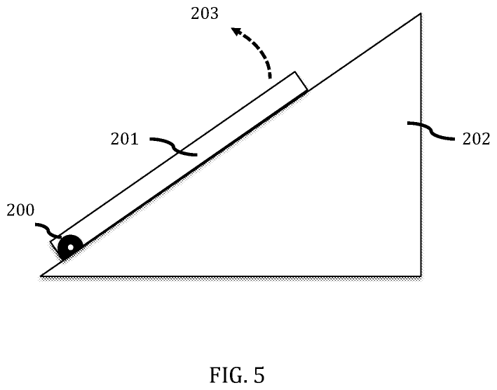

FIG. 5 shows one possible tilting mechanism. The tilting mechanism FIG. 2, 52, FIG. 5 200 201 couples to the base, FIG. 2, 51, FIG. 3, 101, FIG. 5, 202. The tilting mechanism consists of a hinge, FIG. 5, 200, that allows the tilt base, FIG. 5, 201, to tilt up FIG. 5, 203. The tilt mechanism can be adjusted and can be locked in place.

Although the foregoing invention has been described In some detail by way of illustration and example for purposes of clarity and understanding, it may be readily apparent to those of ordinary skill in the art in light of the teachings of this invention that certain changes and modifications may be made thereto without departing from the spirit or scope of the appended claims.

I claim:

1. A system for interconnection of an electronic display device to a center console of a vehicle comprising:
an electronic device, the electronic device comprising a display,
a base,
a pad, the pad comprising a swivel mechanism, the swivel mechanism composed of a ring of ball bearings and two metal plates
a tilt mechanism, the tilt device coupled to the electronic device and coupled to the pad,
connecting straps, the connecting straps attached to the base and used to attached the base to a center console of a vehicle
where a passenger in the front seat of the vehicle rotates the electronic display so it can be viewed.

2. An apparatus for the connection of an electronic display device and a center console of a vehicle comprising:
an electronic display device,
a tilt mechanism, the tilt mechanism comprising:
an adjustable hinge that allows the electronic device to tilt up and down
a pad, the pad comprising a swivel mechanism to allow the electronic display device to rotate clockwise and counter clockwise,
a base, the base comprising:
attachment strap holes on the two opposing sides
attachment straps that thread through the holes
the attachment straps attach the base to a vehicle center console,
whereas the base device attaches to the center console of a vehicle with connecting straps that are threaded through the base device and connect to the center console.

3. The apparatus of claim 2 further including a display on the dashboard, the display electronically coupled with the display on the center console.

4. The apparatus of claim 2 further including a display on the back of a seat, the display electronically coupled with the display on the center console.

5. A method for viewing an electronic device coupled to the center console in a vehicle with both front and backseats, comprising:
an apparatus, the apparatus comprising:
a base, the base comprising attachment straps to attach the base to a center console of a vehicle
a pad, the pad coupled to the base, the pad comprising:
a swivel mechanism comprised of two metal plates and a ring of ball bearings
a tilt mechanism, the tilt mechanism attached to the pad and attached to an electronic console, the tilt mechanism comprising a hinge to allow tilting of the attached electronic console up and down
a first passenger sitting in the front seat swiveling the electronic console to the best viewing angle for the first passenger,
a second passenger sitting in the back seat behind the first passenger, the second passenger then rotating the electronic console to the best viewing angle for the second passenger
whereby both first and second passengers can view the electronic console to their best viewing angle.

6. The method of claim 5 further including a third passenger, the third passenger sitting across from the second passenger, whereby the third passenger rotates the electronic console to the best viewing angle for the third passenger.
